(19) United States
(12) Patent Application Publication
(10) Pub. No.: US 2001/0047384 A1
(43) Pub. Date: Nov. 29, 2001

(54) Methods and systems for providing personalized content over a network

(76) Inventor: John Croy, Middletown, RI (US)

Correspondence Address: FOLEY, HOAG & ELIOT, LLP, PATENT GROUP, ONE POST OFFICE SQUARE, BOSTON, MA, 02109, US

(21) Appl. No.: 09/726,468

(22) Filed: Nov. 29, 2000

Related U.S. Application Data
(60) Provisional application No. 60/167,788, filed on Nov. 29, 1999.

(51) Int. Cl. G06F 15/16; G09G 5/00

(52) U.S. Cl. 709/203; 345/727; 345/760

(57) ABSTRACT

A method, apparatus, system, and computer program are provided for providing personalized content, particularly interactive and relevant audio content over as network. One embodiment uses such personalized content in conjunction with Internet advertising. In one embodiment, content for one type of media (such as visual) may be separately targeted to a user from content for a second type of media (such as audible). Attributes of the content within the media may also be separately targeted. In another embodiment, a set of instructions may be provided to enable the spontaneous generation of audio by the user through the use of user events. This set of instructions may also be selected separately from other media.

### REFERENCE TO RELATED U.S. APPLICATIONS

This application claims priority to U.S. Provisional Patent Application Ser. No. 60/167788, filed Nov. 29, 1999, the entire disclosure of which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

This application relates to the field of media and more particularly to the field of media directed to computer users.

2. Description of Related Art

In many areas it is desirable to draw attention to information presented. One example is advertising. Advertisers have to draw attention to their advertisements from an audience that may or may not be interested in viewing them. This is particularly true in electronic advertising, where the advertiser is competing for attention against content that a user has searched out specifically. In order to better attract attention, advertisers have resorted to many different ways of attracting the user.

Traditionally, advertising across a network such as the Internet or the World Wide Web has been done through the presentation of a viewable window such as a click-able advertising banner. This banner is presented on a page the user accesses for the content provided and when clicked enables the user to be transferred to the advertiser's website, where the user has access to the advertiser's information.

In order to attract the eye of the viewer to these banners, such systems use a variety of techniques. For example, the systems may incorporate animation or interactive displays in order to attract the viewer's attention. Systems can also provide interactive displays where a user can play a game, perform a task, or otherwise interact with the advertisement. Audio content may also be provided to allow the presentation of information outside of a visual media. Such audio is not as interactive as desired, however. The audio is played from an audio file and usually runs on a continuous loop or as a single occurrence. The audio is also associated with a particular advertisement and is not selectable independent of the rest of the advertisement. The audio could not be selected or spontaneously generated in response to user activity. The type of audio available is also limited by the audio files available.

In addition, audio files are usually large, and the transfer of large audio files as part of an advertisement may not be in the advertiser's best interest. Due to the long download time of such files, a user may have moved on to another webpage before the audio is loaded, and/or the time to download of audio files may aggravate the user because the delay induced by the download may hamper his/her browsing, turning the user against the advertiser. Audio files can also use a lot of bandwidth and may have less than desirable sound quality on slower lines or machines.

### SUMMARY OF THE INVENTION

The present methods and systems recognize the above-described problems with conventional advertisements as well as others. First, systems and methods are presented which can provide audio or other content that is personalized for a user. The problem that audio was previously only available in large files which could be slow-to-download, and consume significant bandwidth can be solved. Thus, methods, apparatuses, and computer programs are provided for allowing a server to provide a set of instructions which can be used to generate audio on the user's client, or generate audio on a server and provide the generated audio to a client without the use of audio files. This set of instructions can spontaneously generate audio in a manner that is interactive and personalized to the user. Also are provided systems and methods for selecting audio, other media content, or attributes associated with a multi-media presentation separate from the selection of other media and/or attributes.

In one embodiment there are provided systems and methods for generating data representative of audio comprising, a client, a server in communication with the client over a network (such as the Internet or World Wide Web), and a set of instructions configured to generate data representative of audio in response to a user event generated on the client. The set of instructions may have been transmitted from the server to the client, and/or may comprise a mathematical formula, which may include variables determined by the user event such as the location of a user's pointer. The set of instructions may receive discrete data and/or a stream of data as the user event. The set of instructions may be provided in conjunction with a viewable window (such as a banner advertisement or a viewable window used for commerce, advertising, content, entertainment or other purpose). User events can occur inside, outside, or in any other relation to the viewable window.

The viewable window may be chosen using user profiling data, such as the number of times a user has interacted with similar viewable windows. A second server could also provide some additional content (such as a webpage), that could also be included in the user profiling data.

Another embodiment provides systems and methods for providing multi-media content and/or multi-media Internet advertising (such as a World Wide Web banner advertisement) to a user, the method comprising, obtaining user profiling data associated with a user, selecting, based on the data, content for a first medium, selecting, based on said data, content for a second medium, combining the content for the first medium with the content for the second medium to form multi-media content; and providing the multi-media content to the user.

Another embodiment provides systems and methods for providing content having a plurality of attributes chosen for a particular user comprising, obtaining user profiling data associated with a particular user, selecting, based on the data, the value of a first attribute, selecting, based on the data, the value of a second attribute, assembling content with the first and the second attribute, and providing the content to the particular user.

Another embodiment provides systems and methods for synthesizing audio based on user activity, specifically for generating audio in conjunction with a web advertisement served from a remote server with the intent of engaging the user in an interactive experience. Among other things, a network is disclosed that includes a user with a client coupled to a network, where the client provides requests for material on the network. The client also comprises an a/v display device. In one embodiment, a content provider has a page responsive to these requests for material and further provides requests for viewable windows, such as advertising banners. A second server has at least one viewable window which is responsive to these requests for viewable windows. The viewable window is displayed along with the content on the a/v display device for viewing by the user. In addition, there is included a set of instructions which can generate audio in response to user events generated by the user's interaction with the client.

Another embodiment provides systems and methods for generating audio comprising, displaying at least one viewable window; locating a pointer outside of the viewable window (such as an advertising banner), and generating data representative of audio based on the location of the pointer.

As used herein, the following terms encompass the following meanings.

‘User’ generally denotes an entity, such as a human being, using a device, such as one allowing access to a network. This is typically a computer having a keyboard, a pointing device, and an a/v display device, with the computer running software able to display computer-originated material typically received from one or more separate devices. Preferably the user's computer is running browser software enabling it to act as a client and communicate by the network to one or more servers. The user can, however, be any entity connected to a network through any type of client.

‘Browser’ generally denotes, among other things, a process or system that provides the functionality of a client, such that it interconnects by a network to one or more servers. The browser may be Microsoft's Internet Explorer, Netscape's Navigator, or any other commercial or custom designed browser or any other thing allowing access to material on a network. A browser can also include browser plug-ins.

‘Client’ generally denotes a computer or other thing such as, but not limited to, a PDA, pager, phone, WebTV system, thin client, or any software or hardware process that interconnects by a network with one or more servers. A client need not be continuously attached to the network.

‘Server’ generally denotes one or more computers or similar things that interconnect by a network with clients and that have application programs running therein, such as for the purpose of transferring computer software, data, audio, graphic and/or other material. A server can be a purely software based function. Server also includes any process or system for interconnecting via a network with clients.

‘Network’ generally denotes a collection of clients and servers. A network can include, but is not limited to, the Internet, the World Wide Web, any intranet system, any extranet system, a telecommunications network, a wireless network, a media broadcast network (such as, but not limited to, a broadcast television network, a broadcast radio network, or a cable television network), a satellite network, or any other private or public network.

‘JAVA code’ generally denotes computer software written in JAVA, for the particular purposes of being executed in a browser and being prepared either as an Applet or in some other format. JAVA can refer to any public or proprietary version of, or extension to, the JAVA language. JAVA is a trademark of Sun Microsystems, Inc.

‘Applet’ generally denotes computer software written in JAVA code and prepared in the correct format such as to be able to be downloaded from a server to a browser in accordance with the conventions pertaining to Applets.

‘Active-X’ generally refers to the components of Microsoft's Component Object Model Architecture known as Active-X. This includes any Active-X control written in any language, including, but not limited to, JAVA code, C++, or vb. It also includes any container, or software construct capable of displaying or running an Active-X control.

‘Macromedia Flash’ generally refers to the browser plug-in of that name made available by Macromedia, Inc. This includes all versions, public or private, and any extensions, updates, upgrades or changes to that program whether made by Macromedia, Inc. or any other entity.

‘Player’ generally denotes some system, method, computer program or device for synthesizing audio and presenting the audio in a form that can be translated into audio presented to a user. This can include, but is not limited to; a software process; a mechanical synthesizer; an electronic synthesizer; a mathematical algorithm or function; a device for generating or manipulating electronic signals; JAVA; JAVA code; JAVA applets; Active-X; browser plug-ins such as Macromedia Flash; computer code; or computer hardware.

‘A/V display device’ generally denotes a device for viewing visual and/or audio displays. For a visual display this is generally an LCD or CRT screen where visual information can be displayed. It can however be any device allowing a user to comprehend a visual display including but not limited to, a screen, a paper printer, or a projection device. For an audio display, the a/v display device generally comprises speakers or earphones and a player for translating data representative of audio into audio, whether or not such audio is audible to the human ear. The audio display of an a/v display device may also be, but is not limited to, a computer sound card, a software function, a synthesizer, or any other device which present audio as audible sound. It may also be any device or combination of devices that creates sound waves, or that converts audio into another form for the hearing impaired.

‘Audio’ generally denotes a sound or series of sounds provided to the user. Audio may include, but is not limited to, single tonalities, music, sound effects, human or animal noise including speech, white noise, or any other waveform or combination of waveforms which could be classified as sound waves existing as vibrations, mathematical functions, digital or analog signal, or any other form of a wave.

‘Pointing device’ generally denotes a mouse or similar device which provides a pointer on a visual display. The pointing device can be, but is not limited to, a mouse, a touchpad, a touchscreen, an interactive writing tool, a stylus, a joystick or similar device, a trackpoint system, a roller ball or trackball system, a scroll wheel or button, or a keyboard operation.

‘Pointer’ generally denotes a small graphic present on a visual display whose motion on the visual display is linked to commands presented by a pointing device. A pointer is typically a small arrow on most computer systems but can be any commercial or private graphic whose purpose is to allow a user to interact with graphical displays on the visual display and/or allow the user to have a graphical interface with the device they are using to access the network. The pointer can be static, animated, dynamic or utilize any other type of representation. A pointer can also include a traditional cursor or the highlighting of an area. Alternatively a pointer can be an audio, tactile, or other representation that indicates a position on a display, even if that display and/or position is not visual.

‘Viewable window’ generally refers to any display on a browser that is a component of another display. A viewable window is not necessarily an independent window as understood within the Microsoft Windows or similar operating environment, and can be any predefined portion of a display within such a Window. The viewable window may contain visual information, text, animation, 3D displays or any other type of material. A viewable window may optionally include, or be replaced by, audio or other sensory information, or information for providing feedback via something other than the visual contents of the viewable window. A viewable window will generally be included within a web page but can also be a portion of a chat message, an e-mail message, a proprietary system providing viewable windows as part of a service (for instance, a service providing advertisements in exchange for free Internet access, discounted wireless services, or computer hardware) or any other type of display, including, but not limited to, a television display, a radio broadcast, or a telephone connection. A viewable window includes but is not limited to, a computer window, an advertising banner, or an image file.

‘Advertising’ generally denotes a presentation of material or content, whether single-media or multi-media, which has an at least partial content or component with advertising purpose or connotation. It may include, but is not limited to, solicitation, advertising, public relations or related material, news material, non-profit information, material designed to promote interest in a product or service, information enabling a user to search or view other content providers, or other material that might be of interest to the user.

### BRIEF DESCRIPTION OF DRAWINGS

FIG. 1 depicts an embodiment of one example of a network.

FIG. 2 is a flowchart depicting the steps of independent targeting of different media.

FIG. 3 is a flow chart depicting steps for synthesizing sound according to the present invention.

FIG. 4 depicts a block diagram of one embodiment of a player.

FIG. 5 depicts one embodiment of visual content which could be used in one embodiment of the invention.

FIG. 6 depicts another embodiment of visual content which could be used in one embodiment of the invention.

### DETAILED DESCRIPTION OF THE PREFERRED EMBODIMENT(S)

As an embodiment of the subject invention, the following descriptions and examples are discussed primarily in terms of the method executing over the World Wide Web utilizing JAVA code and/or Macromedia Flash executing within a browser and C++ software executing in a server. Alternatively, the present invention may be implemented by Active-X, C++, other custom software schemes, telecommunications and database designs, or any of the previous in any combination. In an embodiment, the invention and its various aspects apply typically to the user of a personal computer equipped with visual graphic display, keyboard, mouse, and audio speakers, and equipped with browser software and functioning as an Internet World Wide Web client. However, alternative embodiments will occur to those skilled in the art, and all such alternate implementations are included in the invention as described herein.

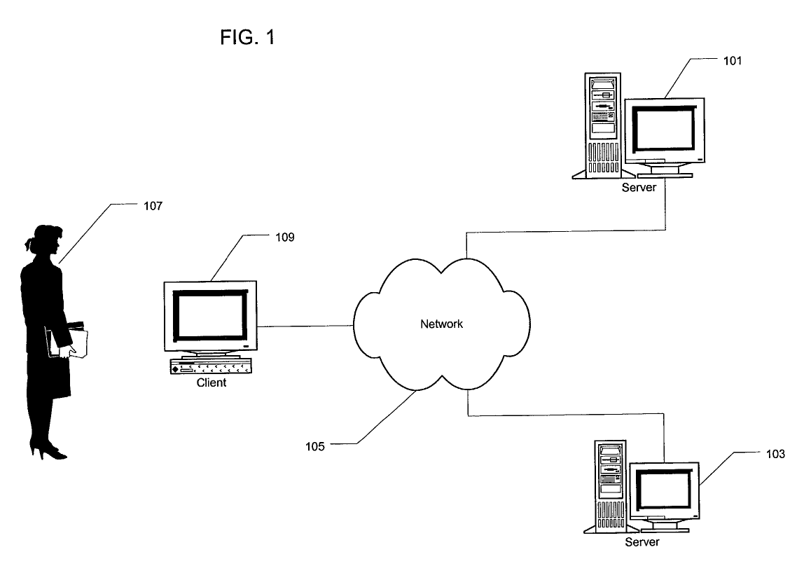

As shown in FIG. 1, a user (107) can access a network (105) such as the World Wide Web using a client (109). Generally the user (107) will be seeking particular electronic content for display on their client (109). This electronic content may be supplied by first server (101) which can be called a content server or a content provider. In addition, when the content is provided by first server (101), additional content may be supplied by second server (103). The content from second server (103) may not have been requested by user (107) and may be supplied without the user's consent to the presentation of such content. In an embodiment, the second server (103) supplies viewable windows for display within the content provided by the first server (101) after requests for those viewable windows are sent from the first server (101) to the second server (103). In an embodiment, the second server (103) may supply graphical or audio content which is presented to the user (107) by the client (109) or may provide computer code or machine commands to client (109) instructing the client (109) to carry out certain actions or enabling the user (107) to perform certain actions on the client (109).

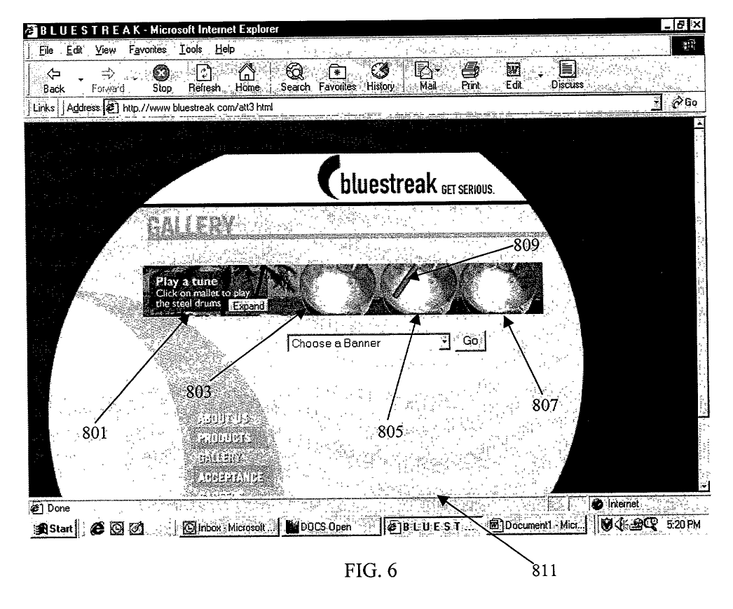

In an embodiment, when a user (107) views network content via a browser, there can exist at least one viewable window within the content which comprises a portion of the total content visible to the user on their physical display device. An example of a viewable window is shown in FIG. 6. In the embodiment pictured in FIG. 6, the viewable window (801) comprises an advertising banner within a web page (803) displayed on the browser (811). This advertising banner will generally take up less than the total area viewable to the user within their browser (811) and the remaining area will contain content from the web page (807). Although the viewable window (801) comprises an advertising banner in FIG. 8, a viewable window does not need to contain advertising and need not comprise an advertising banner. The advertising banner is competing for attention from the content of the webpage. The content has generally been sought out by the user, while the advertisement may be attached to promote something that the viewer might be interested in.

Many advertising banners use multi-media content that flashes, jumps or otherwise attempts to attract the attention of the user through visual, sound, or multi-media cues once the advertisement has been selected and presented to the user to try and attract attention. Content generally comprises a group of components that make up the content and may be provided as one group of selected content across multiple media with no individual selection of components, or as a net content from a plurality of individually selected components. Additionally, spontaneous generation of sound specifically generated for a user, by a users actions can be included to attract attention. Both of these types of interactive content relate to personalizing content, usually of a particular media, that can target a particular user and make him more likely to take interest in the content.

Systems and methods for choosing a viewable window such as an advertising banner to present to a particular user are known in the art. One such system and method is described in U.S. patent application Ser. No. 09/507,828, the entire disclosure of which is herein incorporated by reference. In this disclosure, choosing content, such as the content of a viewable window or an advertising banner will be referred to as targeting. Targeting is generally any method of creating, choosing, selecting or otherwise generating an optimal choice from a set of choices. The optimal choice will usually, but not necessarily, be a choice where the probability of achieving a desired outcome (such as a banner advertisement click-through or the purchase of an advertising product) is maximized. Targeting may, however, be any system or method for determining a content to use or display for any reason. The information used for targeting is generally referred to a user profiling data. User profiling data can enable targeting by providing information (i.e. a profile) on a user. This information may be of any type and could be individualized for a particular user or aggregate information on a plurality of users which share similarity to the particular user, or could be any other type of information which could be used to target content to a particular user. User profiling data can be very personal to the targeted user, or can be based on aggregates of many users, or can be a conglomeration of both. In one embodiment of the invention, the server may store the targeting information and be provided with a key to locate the appropriate information. In another embodiment, the server may receive a trigger to locate targeting information from another source, such as, from the client. All of this information is also user profiling data.

Any methods of targeting known in the art could alternatively or additively be used in targeting, including, but not limited to, where the user is located, a profile of the user, the site where the advertisement appears, the content on the site (textual as well as categorical) where the advertisement appears, and/or the number of times the user has interacted with related advertising or advertisements. An optimization engine can also be used in the targeting. An optimization engine can be any technology that enhances interaction performance of content by altering, choosing, or distorting the behavior, style, or existence of the content.

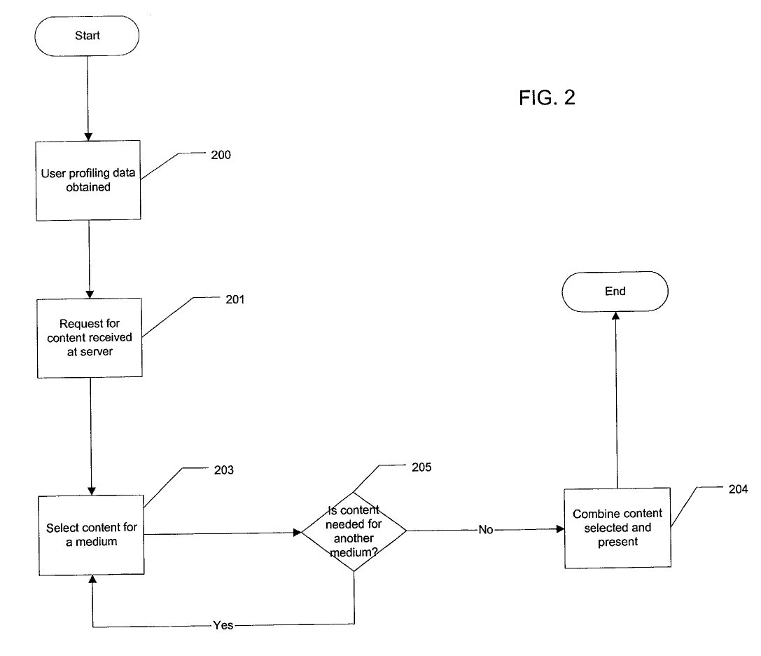

In one embodiment of the invention, individual components of content can be separately targeted to the user. These components will generally relate to content for different mediums. When content is provided, that content may comprise a multi-media presentation. For instance, content can comprise separate content for the audio and visual areas. Content can also be static, dynamic, or animated within each of the media. A multi-media presentation can be a collection of different media all presented together. An embodiment for targeting this media content independently of other media content is outlined in the flowchart in FIG. 2. In FIG. 2, user profiling data is obtained (200) and a request to provide content (201) is received by the server. Once the user profiling data has been obtained, the server can select content to be provided for a medium of the resulting multi-media presentation (203). The server will then determine if all the content has been selected and the multi-media presentation is complete or if additional content for additional media should be selected (205). If additional content should be selected, the system will loop back and continue selecting content until all the media have had content selected. When all the components are selected, the system will provide all the components as the content (204) and will complete its task.

In another embodiment, the looping shown in FIG. 2 could select multiple sets of content for the same medium. There is no requirement that the selections be of different media. One embodiment of the invention includes selecting content in the same media. Along the same lines, any resulting content could be considered multi-media content as the content (even if in a single media) can be considered multi-media where all but one media are selected to be off (not present) or a default. In addition, the term media can mean a traditional media (such as graphical media, or audio media) but can also mean a non-traditional media.

Although FIG. 2 primarily discusses the selection of content in different media, it is also possible for the system to go back and select additional content based on desired attributes of the content. An attribute of the content could be any variable portion of the content which could be altered. Considering a visual graphic display provides many attributes such as, but not limited to, the background color, the foreground color, the existence of any images, the color of any images, the font of text, the size of text, the color of text, or any other part of content in any medium. The attributes of content can take many forms and may relate to a particular medium. For instance, particular audio content may be selected for the audio medium, then attributes of the audio could be chosen. For instance, its volume could be selected or the audio could be transposed into a particular key. The content for a particular medium and the attributes of any content all are components of the content and, in one embodiment of the invention, those components can be targeted and/or selected separately.

An example of selection of media content where the mediums and attributes can be based on user profiling data may be helpful. A request for content may come in requesting content for a viewable window on the web page located at www.bluestreak.com. When the user accesses www.bluestreak.com for content, a request for a viewable window (content) is sent to a server. User profiling data on that target user is obtained which shows that particular user is identified as having a high response rate for advertisements involving classical CDs and movies starring Sandra Bullock; information about aggregate visitors to www.bluestreak.com is also included in the user profiling data obtained. The server may target a viewable window to this user as follows. The user will be supplied with an advertisement for the DVD of the movie “Forces of Nature” which stars Sandra Bullock. Further, an instrumental track from that movies soundtrack (as opposed to a more rock and roll track) will be provided to play in the background to appeal to the user's taste for classical music. Further, the fact that the user is coming from www.bluestreak.com can be used by an optimization engine to select the animated version of the DVD advertisement (over the static one), with a sound volume higher than average, and with all the colors shifted towards the blue end of the spectrum, because visitors to that page as a group generally respond better to advertisements with these attributes. Each of these selected components comprises a choice of content for a particular medium or the selection of an attribute of content to create the resulting multi-media presentation. In this example, the presentation (resultant content) is in the form of an Internet advertisement.

It should be clear that the selection of certain components may effect the outcome of other components. Further, although the example above primarily shows distinct parts (characteristics) of a user profile corresponding to a particular choice of a component of the content, a characteristic may select multiple components or multiple characteristics may select a single component. Further, characteristics within the profile may be in conflict, or may together imply something different than they would separately. Any of these can be taken into consideration in selecting the component content which will eventually make up the multi-media content.

It would also be understood by one of skill in the art that a particular user profile could select multiple different selections of content within each medium. This could result in a plurality of different combinations. These combinations could further be selected between based on any manner known to those skilled in the art. For instance, a particular combination of components a user has seen before may be less likely to be presented than a novel combination. Alternatively, a user may be presented with content that shares components with content they have positively responded to before.

It would also be understood by one of skill in the art, that a selection of content for a particular medium does not require any content to be presented to the user for that medium. For instance, in one embodiment of the invention, the audio could be selected to be no audio. Such a selection may be desirable if a user is identified by the profiling data as having low bandwidth so the download of a sound file may slow down their system, or if the user profiling data indicated that the user had no interest in audio (for instance if he had no device for playing audio).

In another embodiment of the invention, the selected combination may also be stored along with the user's interaction with or interest in the resultant combination and that information can be used in the selection of future combinations.

What occurs in all of these embodiments is that the targeting of content (the choosing of optimal content) is not necessarily targeted as a macroscopic group but the individual components of content can be targeted independently of each other, and the resulting content may be personalized for the user who is presented with it.

The methods and systems discussed above relate to the targeting of audio and other components of content downloaded to a user independently of each other. In addition, there is a desire to make audio more interactive and personalized to the user after it is downloaded. In the above embodiments, the audio can be in an audio file selected and provided to the client. However, in another embodiment, the sound can be spontaneously generated by the user and in response to the user's actions through the use of user events. In addition, the two may be combined to enable the spontaneous generation of audio where the details of the generation is targeted to the user.

Viewable windows and/or content are often provided using hypertext mark-up language (HTML). Transferring a viewable window which contained audio information may include the HTML of the viewable window including code to draw the visible portion of the viewable window and control the other visual aspects of the window, and an audio file which contained a selection of pre-generated music to be played. This audio file may not be very interactive and interactive sound may require a significant number of audio files. In one embodiment, the HTML does not contain the audio file or reference audio files, but includes a set of instructions which comprise computer code and/or data to enable the spontaneous generation of audio on a player either already on a client, provided as a part of the content, or remaining on the server. The HTML could include, but is not limited to, browser plug-in program codes, such as, but not limited to, Macromedia Flash; JAVA code; Active-X; or any built-in HTML codes to provide this functionality.

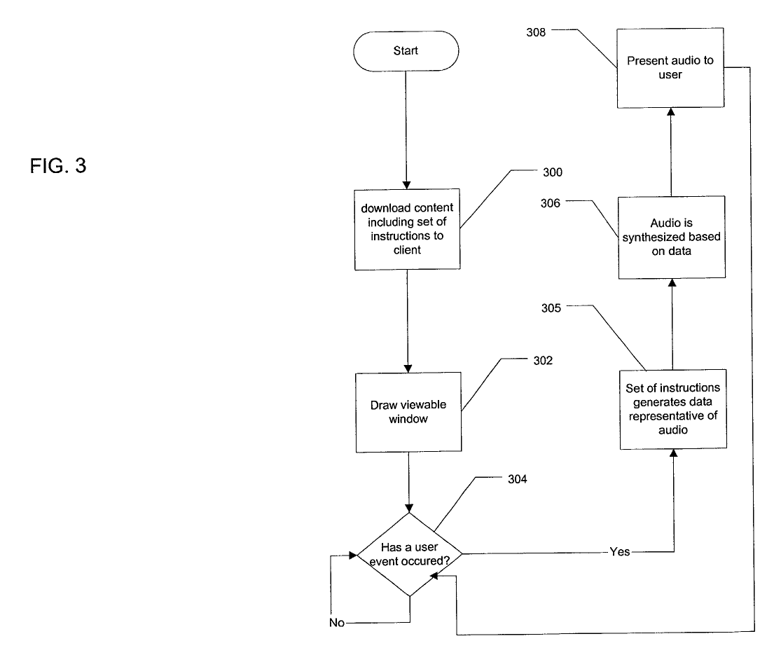

FIG. 3 shows a flowchart of the actions of an embodiment of the invention to spontaneously generate audio. First, content including the set of instructions are downloaded to the client (300). The viewable window is then drawn on the user's browser (302) to display the viewable portion of the content. The set of instructions then waits for a user event to occur (304). When a user event occurs, a set of instructions generates data representative of audio based on that user event (305). A player then synthesizes the audio associated with the current instruction(s) (306) and possibly other variables. This may be a single tone associated with the user event, or can result in the generation of a complicated series of such tones, or the generation of any other type of audio. Once the audio associated with the user event has been synthesized (306), The audio is presented to the user by the a/v display device (308). Any time after the audio has been generated, the set of instructions again waits for another user event to occur (304) starting the generation of audio again. It would be understood by one of skill in the art that FIG. 3's order could be modified and still be included within the scope of this disclosure. For instance if another user event occurred before the user had heard the audio, or all of the audio, the system could immediately begin to recalculate the new audio and play the new audio without playing the old audio or could interrupt the old audio.

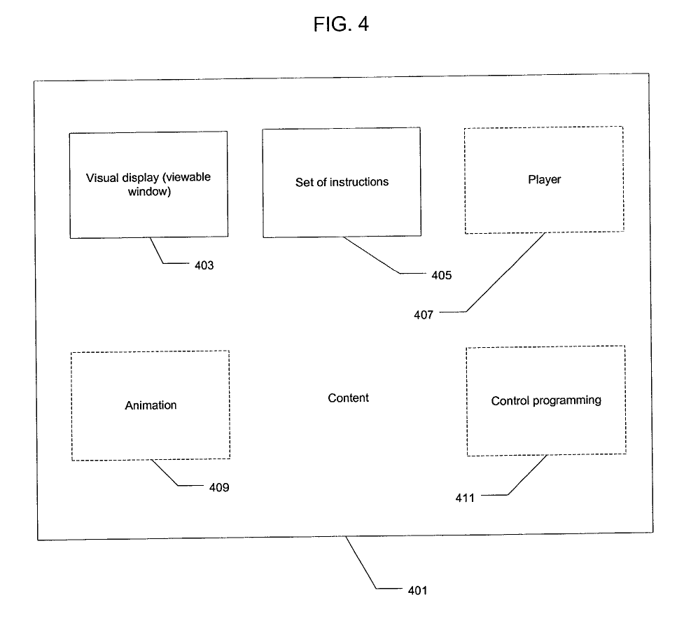

In the above described embodiment of this invention, the content provided by the server comprises information or code which is downloaded to the client. FIG. 4 shows a block diagram of what can be transmitted. The content file (401) may include a visual display (403), and the set of instructions (405). The content may also include other items such as a player (407), animation (409), control programming (411) (such as, but not limited to, commands for locating information on the client, or instructions for the client to carry out an action), or any other type of information. This information may be transmitted as programming code, as instructions, or in any other form that could be interpreted by the client.

One embodiment means that large audio (e.g. .adf) files do not need to be downloaded for interactive and/or personalized audio to be played. Instead, only the instructions for the generation of audio need to be transmitted. The difference is best seen through example. An audio file would contain data representative of audio, that data could be transmitted to the a/v display device and be presented as audio. If there was to be user triggering (the generation of user events) of the audio, there would need to be some form of lookup attached to the audio which would enable a user event to be detected, and an appropriate audio file to be transferred to the a/v display device. To put another way, the audio data was already generated, it is now searched out and played.

In the instant invention, no audio data exists until the set of instructions generate the audio. Since the audio is being generated as it will be presented to the user, there is no need to download all the audio data before or during the playing of the audio. Only the downloading of the instructions for generating audio occurs prior to playing and the sound is generated when requested. This allows both for audio to be highly interactive and can speed up audio delivery. The speed is particularly noticeable for audio that enables a wide selection of different tones or sounds. Audio which is not required, is also not generated, saving processing resources, transmission time, and memory. For example, there is no need for a victory song to be generated unless the user wins an interactive game. If the user fails to win the game (or even to play) the audio data is not generated and the audio is not synthesized. Thus, the invention can save processing resources, allowing network downloads to proceed faster because unnecessary audio files are not downloaded and do not need to be available for download.

In one embodiment of the invention, the set of instructions (403) utilizes user events to enable the audio to be generated in response to user actions so as to further personalize the audio presentation to a user. The set of instructions need not be triggered off of a user action, and in other embodiments can be determined based on preset criteria or triggers. Any item resulting in an instruction from the set of instructions can generate audio.

In one embodiment, the set of instructions (403) can be a mathematical equation (such as a time series) that describes the wavelength and amplitude of a sound wave that is to be generated by the audio outputs on the a/v display. The set of instructions (403) does not need to be mathematical and the set of instructions (403) can be any structure which allows the generation of data representative of audio based on events. One embodiment of this invention allows for user interaction to trigger or control the sound, therefore an appropriate set of instructions (403) could be a mathematical function of the general form:

s=ƒ(t,u) [1]

Which synthesizes audio by generating time series values, where the signal s represents the synthesized audio and is a function of time and instructions. Time (t) may be in units of seconds or other desirable units and may be provided by an internal clocking mechanism, clock signal, or by any other method of determining the passage of time as understood by one of skill in the art. The user function (u) presents values associated with particular user events to determine what particular sound or combination of sounds should be generated. It is therefore generally discussed in terms of a series of commands. In one embodiment, the user function (u) could be another mathematical equation possibly of the form:

u=ƒ(m,k) [2]

This equation is particularly related to a sound synthesizer designed to generate sound in response to a user's interaction with the client. Even more particularly, in this case, a form is provided where m represents pointer actions and k represents keyboard actions. In one particular embodiment m is in units of x,y screen coordinates and k is in units of keycodes. Therefore the user event could be considered a keyboard strike, a pointer click, or even the existence of a pointer on the display. The last item in this group makes a user event correspond to a mouse event. A mouse event occurs to indicate the position of a pointer on the display and may occur as a steady stream or time series in itself. Therefore, a user event may relate to the action of a user, but need not be generated only in reaction to the user. The above example could generate a stream of user events that change as the user interacts. The functions (s) and (u) shown above are exemplary of one embodiment and could also be functional equations, algorithmic operations consisting of program codes or comprising if-else statements, constants, equations based on additional or different variables or any other type of function enabling the generation of data representative of audio.

Programmatically in the equations above, blocks of values may be generated from the user function, then passed to the set of instructions which then builds an array of time series values which represent the sound to be synthesized and passes the array to the player. This process is repeated, updating the t and u values to equation [1]. As the arrays are passed to the player, audio is synthesized which the user hears over the a/v display device.

The set of instructions will often be of one of two forms. The first of these, is the generation of audio based on a pre-selected pattern for audio synthesis, triggered by the user event. The second generates audio where a component of the user's action is included in the pattern of generation. The forms are not particularly different, but relate to how the user events are incorporated into the set of instructions to generate the data representative of audio.

The set of instructions can include code for pre-selected patterns of audio represented by symbolic instructions corresponding to a sequence of waveforms served from a web server. The audio of this embodiment of the invention is then generated when a user event occurs. The following is one example of how this could occur. The user event could be the placement of the pointer over a particular place on the client's visual display (for instance over the viewable window or a display of a noise making device within the viewable window). The predetermined audio could be a list of equations or variables in the set of instructions to be converted into data representative of audio. One example would be that the instruction could comprise inserting a particular series of numbers into a variable in a equation to play a simple tune.

The user event could be any trigger of user action or inaction, automatic occurrences, or other triggers and could include, but is not limited to, completion of the downloading process, the passage of a preset period of time, a user action such as a mouse click or keyboard stroke, an interactive occurrence such as the user's victory in an interactive game, a pointer's location, or a pointer's motion. The existence of the user event is provided to the set of instructions which then determines the audio is to be played. An example of this type of instruction is that when a user wins an interactive game (the triggering event), a value in the set of instructions is set to “TRUE” or “1” this value is used to select the victory song (as opposed to the silence which had existed previously) which is synthesized at that time.

In another embodiment, the set of instructions is constructed such that when the user moves their mouse over a region within a viewable window, a tone corresponding to musical note (such as “A”) is played. In this example, the triggering event occurs on a time schedule, regularly monitoring the position of the pointer. It could alternatively occur whenever a pointer event changes (for instance when the pointer is moved). If the pointer is within the region, u is set to a value of one, if the mouse pointer is outside the region, the value of u is zero. One example of such a equation which synthesizes the value of “A” is:

$$s = u sin ( \frac{2 π {f}_{s}}{440} )$$

u=1 if mouse in region, otherwise 0 [3]

ƒₛ=sample rate

This particular embodiment would be useful to allow the user to interact with the viewable window in the following fashion. A series of “keys” or “instruments” could be displayed to the user such that each key was positioned in a certain area. Each of theses areas could then have a function, similar to [3] above, corresponding to a waveform for the value of that key. A user could then move a mouse pointer over the keys and play a tune.

A further embodiment of the invention allows for the synthesizing of a series of sounds for a single user function value: This would allow a song, tune, or sound effect to be played when a specific trigger event occurs, in this case the mouse being within a region.

$$s = u sin \{ \frac{( 2 π {tf}_{s} )}{440 \vert \frac{1}{3} + \vert cos ( \frac{1}{40} π {tf}_{s} ) \vert ]} \}$$

u=1 if the pointer in the area, otherwise 0 [4]

ƒₛ=sample rate

This set of instructions enables the synthesis of varying tones while the pointer is in the region. These embodiments are only a few simple examples and it will be understood by one skilled in the art that almost any collection of sounds can be represented in these types of equations or functions and can thus be synthesized as part of the invention. In addition, it would be understood by one of skill in the art that mathematical instructions are not necessary. For instance, the instructions could consist of a lookup table.

In another embodiment, the set of instructions could comprise commands for including user actions (or inactions), or the means for creating such commands, in the audio generation. This is the composing of user-generated audio. In this embodiment, the set of instructions comprises a formula or other method for generating audio which uses variables which correspond to a particular part of the user event to compute the audio waveform (as opposed to turning the audio waveform “on” or selecting an audio waveform). In this case, the sound function incorporates the shifting of the variable by the user into the tone generated. This embodiment includes, but is not limited to, generating audio based on the position of the pointer, generating audio based on keyboard strikes, and generating audio based on mouse clicks. An example would be a triggering event comprising the existence of a pointer. The X-coordinate location of the pointer could be included in a mathematical formula generating a sine wave which corresponds to audio.

Equation [5] below describes a sound generation function and user function whereby the user's action is directly translated into the sound produced, the player is here constructed such that when the user moves their pointer horizontally over a region in an advertisement, where the advertisement is 100 pixels wide, a tone with varying tonality is played:

$$s = sin ( \frac{2 π {tf}_{s}}{440 u} ) \\ u = 1 + ( \frac{{Px}_{ptr} - 50}{75} ) \qquad [ 5 ]$$

ƒₛ=sample rate

Pxₚₜᵣ=Position of the pointer in the horizontal (X-coordinate, 1-100) within the viewable window.

This is a variation on equation [3] where the user function directly uses input in the form of variables from the user event. The sound's tone is generated by the nature of the action as opposed to the sound being triggered by an action. This type of audio generation is personalized to the user, as the exact sounds made depend on the particular actions made by the user, therefore a particular sound may be generated for a user spontaneously by the user's action.

Appendix A provides JAVA code for implementing an embodiment of the invention using a set of instructions similar to equation [5] above. However, the code in Appendix A is slightly more complex. When the pointer is moved horizontally the pitch of the audio changes, when the pointer is moved vertically, the volume of the audio changes.

Appendix B provides code for an embodiment of an applet pertaining to the player described by Appendix A.

Another embodiment of the invention combines embodiments of the generated audio and/or audio files with the instructions providing a list of pre-selected audio simultaneously and/or serially being combined with spontaneous audio. Such a system can include, but is not limited to, systems where a user can try to repeat a sound pattern presented by the player by clicking certain areas of the viewable window (for example, an audio memory game), or systems where the user can interact by mixing their spontaneous audio with pre-generated audio to form a composite audio performance (for example, a karaoke style performance).

The player outputs the sound data in a form which the client can present for the user on the a/v display device. In one embodiment, the player can interact with a computer's sound card using the associated programming interface, which accepts commands for playing either time-series samples or midi commands. The synthesized audio generated can be a time series waveform that could include, but is not limited to, musical notes, pre-programmed sound effects, dynamically generated sound effects, and tones. This allows the set of instructions to comprise mathematical representations of waveforms which can then be computed into audio or to utilize pre-generated audio already in the player or downloaded to the client.

In addition to generating audio, an embodiment of the current invention also comprises the use of interactive audio with video. In this embodiment, the audio is linked to the visual content of the viewable window so that the audio provides additional interaction with the video. The audio can thus be logically related to the video allowing the audio to enhance what the user is seeing. This can be performed in many ways, and can include, but is not limited to, synthesizing audio to correspond to when the pointer is over visual “keys” allowing the user to play a virtual instrument, synthesizing audio to correspond to when the pointer is over visual notes, synthesizing audio to provide instruction or feedback in an interactive game, or synthesizing audio to provide sound effects related to the user's visual interaction.

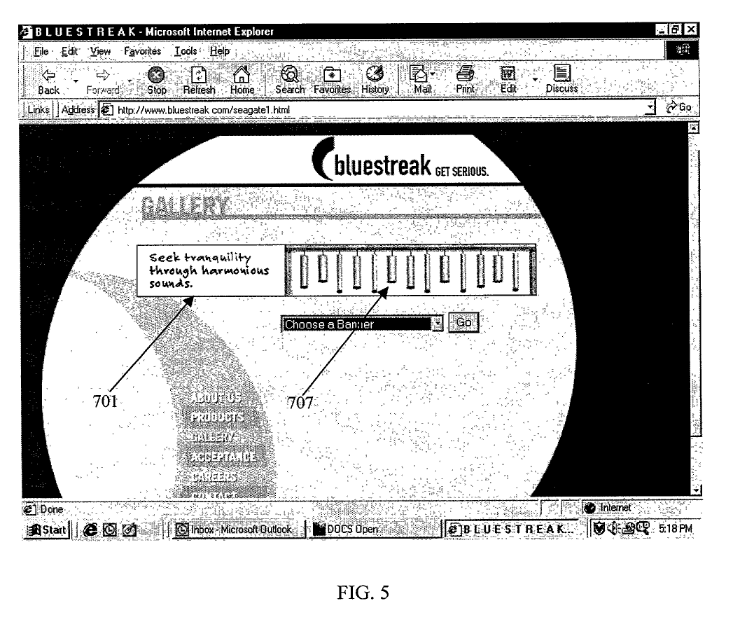

FIGS. 5 and 6 show two examples of viewable windows which can be used in one embodiment. In FIG. 6 the viewable window (801) may encourage a user to play the steel drums (803), (805), (807) depicted in the viewable window. A particular steel drum tone can be synthesized when the user's pointer (which is associated with the visual display mallet (809)) is placed over a drum. Alternatively a particular audio file can be chosen and played when the user is over a particular drum. In FIG. 5 the user is encouraged to move their pointer over the windchimes (707) in viewable window (701) generating (or selecting) tones as the chimes are passed over. FIGS. 5 and 6 also can use animation to move the mallets, drums or wind chimes as they are touched to enable a further interactive experience in accordance with another embodiment of the invention.

Referring again to FIG. 4, the content can be of the form of a multi-media presentation, and may have a plurality of attributes. One medium (or attribute) can comprise the set of instructions (403). This could be targeted as discussed above. For example, multiple sets of instructions could be present on a server and a particular one could be selected and targeted to a user. These instructions may change the tunes associated with particular keys for instance. In another embodiment, the audio memory type game discussed above could be downloaded so the possible tones (and the repeat patterns) changed every time the user saw the window enabling the user to have a new experience each time they saw the game. In another embodiment, the instructions could contain randomizing variables which could be selected as separate components. In another embodiment, multiple sets of instructions (or other components) could be downloaded at one time along with additional instructions for selecting between the sets and/or components. In still another embodiment, the set of instructions itself could be customized based on the user profiling data. For instance, the instructions could contain a mid-level volume variable (or a desired transposition of all the tones) which was set before the set of instructions were downloaded based on the user profiling data.

Embodiments of the invention are not limited in their control of attributes of audio and could control any attributes of the audio including, but not limited to, pitch, volume, quality, tone, type, speed or other characteristics of the audio. An embodiment could implement such control by allowing the user to control volume by moving the pointer or by other means or methods.

Further, all the above embodiment discuss controlling the audio when the user is interacting within the viewable window. Such interaction is not necessary and the user's actions could trigger audio whenever desired, this means that a user's interaction with content outside the viewable window could trigger audio effects to be generated by the set of instructions associated with the viewable window. Systems and methods for capturing, recording, or otherwise using pointer actions outside the viewable window are discussed in U.S. patent application Ser. No. 09/690,003 the entire disclosure of which is herein incorporated by reference. Such systems and methods could be used to control the audio in this invention in one embodiment.

In a further embodiment sound can be generated on a device which is only temporarily attached to a network, even when the device is not connected to the network. In particular, the invention has use on devices such as palmtop computers, cellular telephones, personal digital assistants (PDAs) or other devices that can readily be connected and disconnected from the network. These devices can not receive information from the network when they are disconnected from it. Therefore, an interactive audio system using an audio file would be forced to download audio corresponding to every possibility of desired audio to the device before it was disconnected from the network. Such temporarily attached devices often have very limited memory resources and such massive amounts of audio data may be undesirable. A set of instructions (and possibly a player), however, can be downloaded to the device, and all the audio can be generated when needed, saving resources. Further, a plurality of sets of instructions and/or other components may be downloaded to have a maximum of functionality for a potential minimum of space. In one embodiment, the choice of what is downloaded can be based on user profiling data including information related to a user's interaction with the content when the device is not connected to the network.

In the above described embodiments, the set of instructions was transferred to the client by the server. Referring again to FIG. 1, in another embodiment, the set of instructions remains on the server (103) and is only activated when specific audio is needed. This embodiment also allows for highly interactive audio without the delay or large file transfer problems because a large audio file is never shipped across the network (105). Instead, when the audio is desired at the client (107), a signal is sent to the set of instructions on the server (103) containing user event information or other information to trigger the synthesis of audio, user interaction information, or other information. This can be a small packet that can travel quickly. The set of instructions can then generate appropriate data representative of audio, and feed the data back to the client via the network. The data output can also be a smaller file enabling faster download and less waiting because it may be only a component of the total audio. In another embodiment, the audio may be synthesized on the server by a player on the server and the synthesized audio may be provided over the network to the a/v display for presentation.

The difference between the set of instructions and an audio file can be more clear by considering a prior example. A viewable window could contain what appears to be a piano keyboard having ten keys and encouraging the user to “play a tune.” When the user's pointer hovers over a key or clicks on a key, a sound associated with that key is generated. Using an audio file, the viewable window would need to be downloaded which contained 1) the code for building the visual representation of the keyboard, 2) code for locating the user's pointer and 3) ten audio files, one for each of the ten keys and a method for selecting which of the sound files to play given the location of the user's pointer. The instant invention might still have the first two components, but instead of the sound files it could contain a set of instructions for generating the appropriate data representative of audio which is in the sound files. Now, if the user was to play a single tone on the keyboard and then leave, the traditional system would have downloaded nine sound files which contained unnecessary information, while the embodiment of the instant invention would generate just the single desired sound and could have no unnecessary information.

In addition, because the sound is synthesized on demand, the server does not need to store audio files and can instead maintain multiple sets of instructions to provide audio to multiple different clients. The sets of instructions being selected by any method known in the art for selecting audio for a particular viewable window including the methods described herein. This could save space on the server as the audio file does not need to be stored.

The above discussions are not the only way that personalized audio could be generated and supplied to a user of a client but are representative of the methods and systems that such a transfer may be accomplished. Other methods and systems include, but are not limited to, players comprising code on either the client or server whether shipped with the viewable window, resident on the system, or otherwise made available for use by code in the viewable window download; players comprising hardware either connected directly to the client or server, or indirectly (for instance by means of a network); or players comprising any combination of the above. Further a set of instructions could include instructions to access sounds already stored in any of the above devices. All of these embodiments show ways the invention can be used to synthesize audio in conjunction with a viewable window such as a banner advertisement. The audio need not be synthesized through a viewable window to be within the scope of this invention.

While the invention has been disclosed in connection with the preferred embodiments shown and described in detail, various modifications and improvements thereon will become readily apparent to those skilled in the art. Accordingly, the spirit and scope of the present invention is to be determined by the following claims.

APPENDIX A
import java.awt.*;
import java.applet.*;
import java.net.*;
import java.io.*;
import java.awt.image.*;
class TuneGenerator extends InputStream
{

public static final int AU=0,WAV=1,AUSAMPLERATE=8012;
private static final byte EXPONENT[ ]= {

0,0,1,1,2,2,2,2,3,3,3,3,3,3,3,3,
4,4,4,4,4,4,4,4,4,4,4,4,4,4,4,4,
5,5,5,5,5,5,5,5,5,5,5,5,5,5,5,5,
5,5,5,5,5,5,5,5,5,5,5,5,5,5,5,5,
6,6,6,6,6,6,6,6,6,6,6,6,6,6,6,6,
6,6,6,6,6,6,6,6,6,6,6,6,6,6,6,6,
6,6,6,6,6,6,6,6,6,6,6,6,6,6,6,6,
6,6,6,6,6,6,6,6,6,6,6,6,6,6,6,6,
7,7,7,7,7,7,7,7,7,7,7,7,7,7,7,7,
7,7,7,7,7,7,7,7,7,7,7,7,7,7,7,7,
7,7,7,7,7,7,7,7,7,7,7,7,7,7,7,7,
7,7,7,7,7,7,7,7,7,7,7,7,7,7,7,7,
7,7,7,7,7,7,7,7,7,7,7,7,7,7,7,7,
7,7,7,7,7,7,7,7,7,7,7,7,7,7,7,7,
7,7,7,7,7,7,7,7,7,7,7,7,7,7,7,7,
7,7,7,7,7,7,7,7,7,7,7,7,7,7,7,7);

private static final int BIAS = 0×84;
private static final int CLIP = 32635;
int count = 0;
int tone = 4000;
int volume = 100;
int x=0;
private byte toMu(int sample) {

int sign;
if (sample < 0) {

sample = −sample;
sign = 0×80;

| } else | sign = 0; |
|---|---|
| if (sample>CLIP) | sample=CLIP; |
| sample = sample + BIAS; | |
| int exponent=EXPONENT[(sample>>7) & 0×ff]; | |
| int mantissa=((sample>>(exponent+3)) & 0×0f); | |
| int ulawbyte =((˜(sign \| (exponent <<4) \| mantissa))&0×ff); | |
| if(ulawbyte==0) | ulawbyte = 2; |

return (byte)ulawbyte;

}
public int read(byte arr[ ], mt offset, int len)
{

int ret = −1;
try{

++count;
if (count > 2)
{

int i,j;
for (i=0; i<len; i++, x++)
{

double val = Math.sin((double)x/

(double)AUSAMPLERATE * tone) * (double)volume * 100;

val += Math. sin((double)x/(double)AUSAMPLERATE *

2 * tone) * (double)volume * 100;

arr[i] = toMu((int)val);

}
ret = len;

}

} catch (Exception e)
{ }
return len;

}
public mt read( )
{

byte arr[ ] = new byte[1];
read(arr, 0, 1);
return arr[0];

}
public void setTone(int t)
{

tone = (int)( (double)tone * .9 + .1 * (double)t);

}
public void setVolume(int v)
{

volume v;

}

}
public class Synth extends Applet
{

TuneGenerator is = null;
URL Connection uc;
public void init( )
{

try{

is = new TuneGenerator( );
sun.audio.AudioPlayer.player.start(is);

} catch (Exception e) { }

}
public boolean handleEvent(Event event)
{

is.setTone(event.x * 10);
is.setVolume(event.y * 10);
return super.handleEvent(event);

}

}

1. A system for generating data representative of audio, the system comprising:
a client;
a server in communication with said client over a network; and
a set of instructions, said set of instructions being configured to generate data representative of audio in response to a user event, said user event being generated on said client.

2. The system of claim 1 wherein said set of instructions comprises a mathematical formula.

3. The system of claim 2 wherein said mathematical formula comprises variables, the value of which is determined by said user event.

4. The system of claim 3 wherein said variables are related to the coordinates of a user's pointer.

5. The system of claim 1 wherein said set of instructions receives a stream of data as said user event.

6. The system of claim 1 wherein said set of instructions is transmitted from said server to said client via said network.

7. The system of claim 6 wherein said set of instructions is transmitted in conjunction with a viewable window which is displayed on said client.

8. The system of claim 7 wherein said user event occurs outside said viewable window.

9. The system of claim 7 wherein said user event occurs within said viewable window.

10. The system of claim 7 wherein the said viewable window has content used for commerce, advertising, or entertainment purposes.

11. The system of claim 7 wherein said viewable window comprises an advertising banner.

12. The method of claim 7 wherein the content of said viewable window is chosen according to user profiling data.

13. The method of claim 12 wherein said user profiling data includes the number of times a user has interacted with other viewable windows.

14. The method of claim 7 further comprising a second server, said second server providing content to said client.

15. The method of claim 14 wherein the content of said viewable window is chosen according to user profiling data.

16. The method of claim 15 wherein said user profiling data includes reference to said content provided by said second server.

17. The method of claim 14 wherein said selected content comprises a web page.

18. The method of claim 1 wherein said network is chosen from the group including Internet and World Wide Web.

19. A method for providing multi-media content to a user, the method comprising:
obtaining user profiling data associated with a user;
selecting, based on said data, content for a first medium;
selecting, based on said data, content for a second medium;
combining said content for said first medium with said content for said second medium to form multi-media content; and
providing said multi-media content to said user.

20. A method for providing a multi-media Internet advertisement to a user, the method comprising:
obtaining user profiling data associated with a user;
selecting, based on said data, content for a first medium;
selecting, based on said data, content for a second medium;
combining said content for said first medium with said content for said second medium to form a multi-media Internet advertisement; and
providing said multi-media Internet advertisement to said user.

21. The method of claim 20 wherein said Internet advertisement comprises a World Wide Web banner advertisement.

22. A network comprising:
a user with a client, said client providing requests for material, and comprising a display device;
a content provider having a page responsive to said requests for material, the content provider providing requests for viewable windows;
a server having viewable windows responsive to said requests for viewable windows; and
a set of instructions, said set of instructions configured to generate data representative of audio in response to user events;
wherein said user events are generated by said user interacting with said client.

23. The network of claim 22 wherein said viewable windows comprise advertising banners.

24. A method for generating data representative of audio comprising:
displaying at least one viewable window;
locating a pointer outside of said viewable windows; and
generating data representative of audio based on the location of said pointer.

25. The method of claim 24 wherein said viewable window comprises an advertising banner.

26. A method for providing content having a plurality of attributes chosen for a particular user, the method comprising:
obtaining user profiling data associated with a particular user;
selecting, based on said data, the value of a first attribute;
selecting, based on said data, the value of a second attribute;
assembling content with said first and said second attribute; and
providing said content to said particular user.
